(19) United States
(12) Patent Application Publication
(10) Pub. No.: US 2007/0101624 A1
(43) Pub. Date: May 10, 2007

(54) License plate holder-bracket assembly

(76) Inventor: Daniel W. Records, Olathe, KS (US)

Correspondence Address: Eugene R. Quinn, Jr., 400 Brattle Road, Syracuse, NY, 13203, US

(21) Appl. No.: 11/268,178

(22) Filed: Nov. 7, 2005

(51) Int. Cl. G09F 7/00

(52) U.S. Cl. 40/209

(57) ABSTRACT

The present invention is directed to a license plate holder-bracket assembly that enables the attachment of a vehicle license plate by eliminating the need for costly, time consuming and difficult repairs that presently necessitate the removing and replacing of damaged mounting screws and/or missing attachment points. The license plate holder-bracket assembly provides a clean factory look both in terms of by style, color and texture. In the preferred embodiment, the license plate holder-bracket assembly covers over the existing license plate holder or attachment apparatus with a frame and screws into the vehicle with two ¾ inch drill point screws. There is, however, no requirement that the present invention be placed over an existing license plate holder or attachment means. The present invention could be placed anywhere along the front or rear of the vehicle, or on any device or apparatus, such as a trailer or storage container.

### BACKGROUND OF THE INVENTION

1. Field of the Invention

This invention relates generally to a license plate holder-bracket assembly.

2. Background

It is unfortunately common for license plate screws on an existing license plate holders or attachment apparatuses to be stripped, broken off or not line up properly. This is particularly a problem for older vehicles, but can be a problem for any vehicle new or old. Anyone who has attempted to change a license plate knows that license plate screws can and do present significant problems. Do-it-yourselfers and others will from time to time simply use some type of wire to secure a license plate, but such a fix is hardly desirable because it is certainly not aesthetically pleasing and it greatly increases the risk that the license plate will become dislodged from the vehicle.

Another common fix for the problem of stripped, broken or otherwise defective or broken screws has historically been to drill out the broken screws and re-tap new threads, this is very time consuming and expensive if done in a repair shop, which is where it is most frequently done because do-it-yourselfers do not usually have the equipment necessary (not to mention the time, energy and patience needed) to accomplish the task. Alternatively, some manufactures attach the license plate to the car by attaching two (or more) metal “J-clips”) (or a similar device) to the bumper. Screws are then used to attach the license plate to the “J-clips”. These “J-clips” and screws are exposed to the elements and can become so corroded that the screws can not be removed, if to much pressure is applied and the screws do not come out, the plastic surrounding the “J-clips” will break off of the bumper leaving no place at all for new “J-clips” to be attached necessitating a new bumper skin which in most cases requires the additional expense and time associated with painting the new bumper skin to match the car. (The bumper skin is the plastic outer portion of a bumper—the part that is seen—and it is usually painted the same color as the car or may be black, grey or silver in color.)

Still further, there are items on the market that could be used for the purpose of dealing with such problematic screws and thereby secure a license plate. These units, however, are not designed or marketed for the purpose of attaching a license plate when the existing screws are impaired in some way. Specifically, these other units do not provide a means to cover the problem areas and provide proper clearance without completely removing any remaining damaged mounting screws. They are also of inferior quality and do not provide the same aesthetically pleasing factory look. They also do not come with special drill-point screws to eliminate the need for pre-drilling saving time, effort and the need for additional tools.

Therefore, what is needed is a license plate holder-bracket assembly that does not suffer from the aforementioned problems, and which enables the attachment of a vehicle license plate by eliminating the need for costly, time consuming and difficult repairs that presently necessitate the removing and replacing of damaged mounting screws and/or missing attachment points.

### SUMMARY OF THE INVENTION

The present invention advantageously fills the aforementioned deficiencies by providing a license plate holder that enables the attachment of a vehicle license plate by eliminating the need for costly, time consuming and difficult repairs that presently necessitate the removing and replacing of damaged mounting screws and/or missing attachment points. Moreover, the present invention eliminates the costly replacement, repair and/or painting of the bumper skin as presently required in some circumstances.

The invention overcomes the present deficiencies of prior solutions because it provides the required means of attaching the license plate without necessitating significant expenditures of time, money or energy. Additionally, the present invention allows the attaching of the license plate even by those do-it-yourselfers who are mechanically challenged. Still further, the present invention provides a clean factory look, meaning that the license plate holder and license plate will appear as the would if they were direct from the factory, both in terms of by style, color and texture. Still further yet, the present invention is designed specifically for the purpose of providing a quick, easy and inexpensive way to attach a license plate while giving the desirable factory look, using quality materials and covering any present and/or undesirable damage that may be present. Finally, the present invention overcomes the problems associated with repairing broken screws and/or missing attachment points, and does not require pre-drilling to attach the screws saving time and additional cost and, thereby making short work of replacing any license plate.

The license plate holder can be created by using injection molding, or it can be stamped, cast, machined or produced by any process to allow it to function as described; injection molding is preferred. The license plate holder can be made of plastic, metal, metal alloy, wood, fiberglass or some other similar substance that can provide the required stability necessary for a license plate. In short, the present invention can be made from any material that would allow it to function as described for the purpose of holding a license plate.

Blister pop-ups, which cover the existing screws on the existing license plate holder or attachment apparatus, can but need not be included. If blister pop-ups are included they can either be molded as part of the product or can be made separately and later attached by any means such as, but not limited to, a “snap-in” blister, insert or cover (as depicted in FIG. 4). As an alternative to multiple blister pop-ups, it may be desirable to produce the license plate holder with a single, long blister pop-up. Regardless of the number of blister pop-ups, however, when blister pop-ups are present the function will still be the same. The license plate holder-bracket assembly also includes holes through which the attachment can be made, and the attachment holes can be included to accommodate both domestic (US) license plates and/or to accommodate special and/or foreign license plates.

To use the present invention, one would place it over the existing license plate holder or attachment apparatus. Two drill-point screws are used to attach the present invention directly over the original mounting area such as the bumper or trunk lid. Alternatively, the present invention can also be placed elsewhere along the bumper in the event that the user does not wish it cover the existing license plate holder or attachment apparatus. Such alternative placement may be desirable, among other times, when the user wishes to add an additional license plate, such as a decorative license plate at the front or rear of the vehicle, trailer or other structure, apparatus or device where a license plate is desired. Still further, another alternative use would be as a license plate holder where there is no original mounting place (i.e. a trailer, etc.). Still further, the present invention can be rotated 180 degrees left to right (the bottom becoming the top) to enable the use of the blister(s).The blister(s) would be “popped up” (or separate blisters would be attached) to cover the problem areas, such as damaged non-removable screws and providing new places to attach a license plate (tag).

The normal installation of the present invention would entail driving drill-point screws through mounting holes in the holder into the vehicle, preferably into the bumper or trunk lid. It could, however, be attached with adhesive, high-bond tape, glue or any other means understood to be capable of securing the license plate holder. Additionally, self-adhesive pad(s) could be used to keep the license plate from rattling. The pad(s) could be manufactured from any material such as foam rubber, rubber, plastic, felt or similar material and would be placed between the license plate and the vehicle or trailer, for example, in order to reduce noise.

It is therefore an object of the present invention to provide an easy to use, high quality, low cost license plate holder that enables the attachment of a vehicle license plate by eliminating the need for costly and time consuming repairs of removing and replacing damaged mounting screws and/or missing attachment points.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a top plan view of the invention 10.

FIG. 2 is a side elevation view of the invention 10.

FIG. 3 is a cross section view taken along lines 3-3 of FIG. 1.

FIG. 4 is a plan view showing alternate embodiments of the pop-up blister 18a and 18b.

FIGS. 5A, 5B, 5C and 5D are top plan views showing alternate ways of installing the invention 10.

### DETAILED DESCRIPTION OF THE INVENTION

The present invention is directed to a license plate holder-bracket assembly. One important use for this invention is when screws on an existing license plate holder or mounting area are stripped, broken off or do not line up properly or where a portion of the original factory license mounting area is damaged or missing. It is unfortunately a, common for license plate screws to suffer from these and other related and/or similar problems. When such problems occur one can simply use the present invention to attach a license plate without the time consuming, frustrating and often hopeless attempt to fix and/or reuse the previously present license plate holder or area.

The overall invention 10 is preferably a formed flexible plastic, however, any organic or inorganic material may be used, including metal, metal alloy, fiberglass and wood. In the preferred embodiment, the overall invention 10 covers over the existing license plate holder or attachment apparatus with frame 12 and screws into the vehicle with two ¾ inch drill point screws 20. There is, however, no requirement that the present invention be placed over an existing license plate holder or attachment means. The present invention could be placed anywhere along the front or rear of the vehicle, or on any device or apparatus, such as a trailer or storage container. It is, however, most commonly placed directly over the previously present license plate holder or attachment apparatus.

Those skilled in the art will appreciate that there is a wide range of acceptable size screws. The two ¾ inch drill point screws are specifically mentioned by way of illustration and preference. When picking the screw size it is simply required that the screw be long enough to secure the present invention to the vehicle. Those skilled in the art will also appreciate that the placement of attachment holes can vary depending upon design needs. Further, not all of the attachment holes shown on the attached drawings need to be present. It is only necessary to have enough attachment holes or other attachment means to satisfactorily secure the present invention license plate holder to the vehicle.

The figures utilize reference numerals that correspond to various pieces of the invention as follows:

10 is the invention.

12 is the frame (invention, less the screws)

14a are the recessed spaces

14b are the primary bracket attachment holes used to connect the frame to an object

14c are license plate holes adapted to accept US license plates

14d are license plate attachment holes adapted to accept foreign license plates

14e are alternate bracket attachment holes

16a are blister pop-ups

16b are blister pop-up openings

18a is an alternate blister pop-up or insert

18b is another alternate blister pop-up or insert

20 are drill point screws

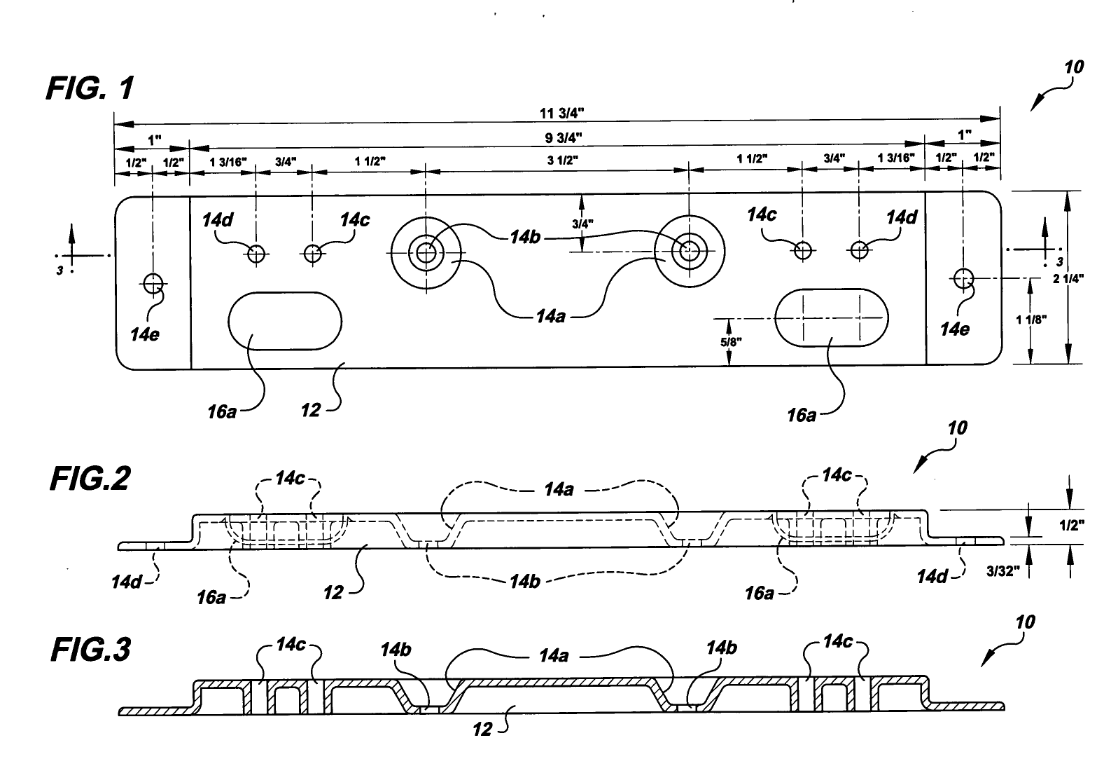

FIG. 1 illustrates a front on view of the present invention 10. The measurements depicted in the drawing are included by way of illustration and to indicate preference, but are not in any way intended to be limiting. Recessed spaces 14a (which are optional) house the house primary bracket attachment holes 14b for attaching frame 12 to an object, such as a vehicle or trailer. License plate attachment holes 14c and 14d are for attaching the license plate to the frame. License plate attachment holes 14c are specifically adapted to accept domestic US license plates, and license plate attachment holes 14d are specifically adapted to accept foreign license plates. It should be readily apparent to those skilled in the art that the frame 12 can come with both sets of license plate attachment holes 14c and 14d, or come with one and not the other. Also depicted are alternative bracket attachment holes 14e, which provide an alternative means for attaching frame 12 to an object, such as a vehicle or trailer. Alternative bracket attachment holes 14e are optional.

FIG. 1 also depicts blister pop-ups 16a, which are another optional feature which cover the existing screws on the existing license plate holder or attachment apparatus. The blister pop-ups are shown in the down position, but can also be in the up or raised position when used to provide clearance of existing damaged or broken screws that can not be removed. The wall thickness for the blister pop-ups would be determined by the material used to make the product. The thickness of the blister pop-ups will normally vary from 0.01 to 0.25 inch depending on need, with the standard being 0.01 to 0.020 inch. Those skilled in the art will undoubtedly appreciate that an innumerable variety other thicknesses are within the scope of this disclosure and these ranges are provided to illustrate norms, preferences and standards and in no way to limit the scope of the invention.

FIG. 2 illustrates a side view of the license plate holder-bracket assembly. FIG. 2 also has specific measurements depicted, which are included by way of illustration and to indicate preference, but are not in any way intended to be limiting. FIG. 2 depicts the frame 12 lying flat and provides a better view of the recessed spaces 14a that house the primary bracket attachment holes 14b. Also depicted are license plate attachment holes 14c and 14d, which demonstrate variations to the formation of these and other attachment holes. Also depicted are the blister pop-ups 16a. FIG. 3 provides a similar view as does FIG. 2; however, FIG. 3 removes the blister pop-ups to more clearly illustrate the license plate attachment holes 14b and 14c, as well as the recessed spaces 14a.

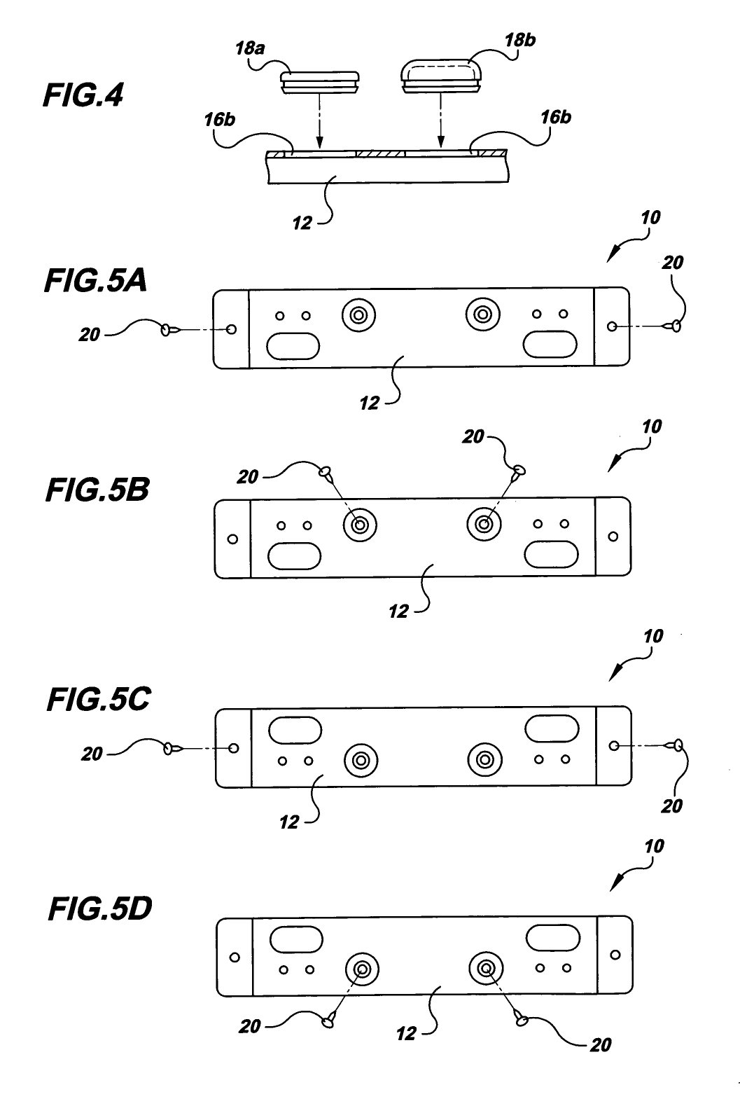

FIG. 4 illustrates an isolated view an alternative to preformed blister pop-ups, using blister pop-up blister pop-up openings 16b to accept alternate shaped blister pop-ups 18a and 18b. This embodiment would be an alternative to the blisters being molded as an integral part of the product. Alternate blister pop-up or insert 18a snaps into blister pop-up opening 16b. In the preferred embodiment blister pop-up or insert 18a is relatively flat and is typically used when there is no need or extra clearance (i.e. no remaining damaged screws). Also depicted in FIG. 4 is another alternate blister pop-up or insert 18b, which snaps into blister pop-up opening 16b and which is, in the preferred embodiment, relatively raised above the surface of the frame 12, forming a covering and providing additional clearance for any existing damaged and non-removable screws.

FIGS. 5A through 5D illustrate various alternative ways of installing the present license plate holder-bracket assembly 10 using drill point screws 20 to attach the frame 10 to the object, such as a vehicle or trailer. It should be understood that these illustrations are exemplary and not limiting.

In one particular embodiment of the present invention, installation of a license place can be accomplished by placing the license plate holder-bracket assembly over the preexisting license plate holding means, lining up the blister pop-ups (if present) of the license plate holder-bracket assembly over the preexisting license plate screws or screw holes (if present), inserting drill point screws through the bracket attachment holes and screwing the drill point screws into the vehicle bumper or trunk lid. In another embodiment of the present invention, installation can be accomplished by placing the license plate holder-bracket assembly over the preexisting license plate holding means, lining up the blister pop-up openings 16b over the preexisting license plate screws or screw holes, inserting drill point screws through the bracket attachment holes, screwing drill point screws into the vehicle bumper or trunk lid and snapping into the blister pop-up openings 16b alternative blister pop-ups 18a or 18b.

It should be understood that these alternative installation methods have been described by way of illustration only and are not intended to be limiting. For example, it is certainly possible to install the license plate holder-bracket assembly on a trailer or storage container. Additionally, there is no particular need to install the license plate holder-bracket assembly over top of a preexisting license plate attachment means.

Once the license plate holder-bracket assembly has been installed one can place a license plate over the license plate holder-bracket assembly, insert license plate screws through the corresponding license plate screw openings, and screw the license plate screws into the license plate holder-bracket assembly.

In still a further embodiment of the present invention, the license plate holder-bracket assembly can be packaged as a kit. Within the kit will be a license plate holder-bracket assembly, drill point screws and license plate screws. The kit can also come with instructions in written, video or audio format.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

It should also be noted that the present invention has been alternatively referred to in this description a “license plate holder-bracket assembly”, “product”, “holder”, “frame”, “license frame” or “bracket.

What is claimed is:

1. A license plate holder-bracket assembly comprising:
a frame having a surface and a plurality of bracket attachment holes of sufficient diameter to accept a drill point screw shank but small enough to prevent a drill point screw head from passing through and a corresponding number of recessed spaces that house the bracket attachment holes;
a plurality of license plate attachment holes of sufficient diameter to accept a license plate screw shank but small enough to prevent a license screw head from passing through; and
at least one blister pop-up disposed on the surface of the frame.

2. A method of installing a license plate holder comprising:
determining which portion of the license plate holder will be placed on top vertically in relation to the vehicle;
placing the license plate holder-bracket assembly over the preexisting license plate holding means;
lining up the blister pop-ups of the license plate holder-bracket assembly over the preexisting license plate screws;
inserting drill point screws through the bracket attachment holes;
screwing the drill point screws into the vehicle bumper.

3. The method of claim 2 further comprising:
placing a license plate over the license plate holder-bracket assembly;
inserting a license plate screws through the corresponding license plate screw openings;
screwing the license plate screws into the license plate holder-bracket assembly.

4. A license plate repair kit comprising:
a license plate holder-assembly;
a plurality of drill point screws;
a plurality of license plate screws;
at least one piece of hi-bond tape
at least one self-adhesive pad; and
a package housing said license plate holder-assembly; said drill point screws and said license plate screws.
